(19) United States
(12) Patent Application Publication
(10) Pub. No.: US 2021/0383029 A1
(43) Pub. Date: Dec. 9, 2021

(54) INFORMATION PROCESSING PROGRAM, INFORMATION PROCESSING DEVICE, AND INFORMATION PROCESSING METHOD

(71) Applicant: SONY CORPORATION, TOKYO (JP)

(72) Inventor: KENTA TADA, TOKYO (JP)

(21) Appl. No.: 17/288,358

(22) PCT Filed: Jul. 24, 2019
(86) PCT No.: PCT/JP2019/028946

§ 371 Date: Apr. 23, 2021

(30) Foreign Application Priority Data
Nov. 2, 2018 (JP) 2018-207290

(51) Int. Cl. G06F 21/84; G06T 11/60; G06F 21/62

(52) U.S. Cl. CPC G06F 21/84; G06K 9/00228; G06F 21/6245; G06T 11/60

(57) ABSTRACT

An information processing program including: operating on one terminal device; transmitting an approval confirmation requesting approval of external output of an image to one or multiple other terminal devices other than the one terminal device; and outputting the image externally on the basis of a response to the approval confirmation from the other terminal device.

### TECHNICAL FIELD

The present technology relates to an information processing program, an information processing device, and an information processing method.

### BACKGROUND ART

In recent years, many users have registered for social media, image sharing sites, and the like on the Internet, and contents such as images have been uploaded daily to the Internet by general users. Additionally, not only images but various pieces of digital data are exchanged over the network. For example, text data, image data, and video data are exchanged through the Internet. Under such circumstances, protection of the privacy of individuals contained in such data becomes an issue.

Against this background, a technology has been proposed to achieve both prevention of privacy infringement and distribution of captured images by distributing captured images after performing processing on the images to remove an object that can identify an individual (Patent Document 1).

### CITATION LIST

### Patent Document

Patent Document 1: WO 2015/136796 A

### SUMMARY OF THE INVENTION

### Problems to be Solved by the Invention

However, the technology described in Patent Document 1 prevents infringement of an individual's privacy by removing an object that enables identification of the individual in the image, but does not reflect the intention of the individual who is the subject in the image, for example. From the perspective of more reliable privacy protection, it is also necessary to reflect the intention of the individual.

The present technology has been made in view of such a point, and aims to provide an information processing program, an information processing device, and an information processing method that can prevent contents including a user's personal information from being output externally unbeknownst to the user and without permission.

### Solutions to Problems

In order to solve the above-mentioned problem, a first technology is an information processing program including: operating on one terminal device; transmitting an approval confirmation requesting approval of external output of an image to one or multiple other terminal devices other than the one terminal device; and outputting the image externally on the basis of a response to the approval confirmation from the other terminal device.

Additionally, a second technology is an information processing device including an approval confirmation unit that operates on one terminal device, and transmits an approval confirmation requesting approval of external output of an image to one or multiple other terminal devices other than the one terminal device, and an output control unit that controls external output of the image on the basis of a response to the approval confirmation from the other terminal device.

Moreover, a third technology is an information processing method including transmitting an approval confirmation requesting approval of external output of an image to one or multiple other terminal devices other than one terminal device, and outputting the image externally on the basis of a response to the approval confirmation from the other terminal device.

### BRIEF DESCRIPTION OF DRAWINGS

FIG. 1 is a diagram showing a configuration of a content monitoring system 10.

FIG. 2 is a block diagram showing a configuration of a terminal device 100.

FIG. 3 is a block diagram showing a configuration of an information processing unit 200.

FIG. 4 is an explanatory diagram of a transaction.

FIG. 5 is an explanatory diagram of a first mode of image division.

FIG. 6 is an explanatory diagram of a second mode of image division.

FIG. 7 is a flowchart showing a flow of user registration processing.

FIG. 8 is a diagram showing a user interface for input to link with an external social networking site.

FIG. 9 is a flowchart showing a flow of approval confirmation transmission processing.

FIG. 10 is a diagram showing a user interface during the approval confirmation transmission processing.

FIG. 11 is a flowchart showing a flow of response processing.

FIG. 12 is a diagram showing a user interface during the response processing.

FIG. 13 is a flowchart showing a flow of external output processing.

FIG. 14 is a diagram showing a user interface during the external output processing.

FIG. 15 is a diagram showing a user interface during the external output processing.

FIG. 16 is a flowchart showing a flow of image decryption processing.

FIG. 17 is an explanatory diagram of cooperation between the content monitoring system 10 and an external social networking site.

### MODE FOR CARRYING OUT THE INVENTION

Hereinafter, embodiments of the present technology will be described with reference to the drawings. Note that the description will be given in the following order.
<1. Embodiment>
[1-1. Configuration of content monitoring system 10]
[1-2. Configuration of terminal device 100]
[1-3. Configuration of information processing unit 200]
[1-3-1. User registration processing]
[1-4. Use of content monitoring system 10]
[1-4-1. User registration processing]
[1-4-2. Approval confirmation transmission processing]
[1-4-3. Response processing]
[1-4-4. External output processing]
[1-4-5. Image decryption processing]
<2. Modification>

### 1. Embodiment

[1-1. Configuration of Content Monitoring System 10]

First, a content monitoring system 10 of the present technology will be described. The content monitoring system 10 includes multiple terminal devices 100 and a server device 1000.

The server device 1000 is a content monitoring server owned and managed by a business operator or the like that provides a service of the content monitoring system 10 according to the present technology. The server device 1000 stores account information, registration information, and the like of a user who uses the content monitoring system 10. Additionally, the content monitoring server stores a dedicated application for the content monitoring system 10 (hereinafter referred to as dedicated application), and provides the dedicated application in the form of downloading or the like in response to a request from the user.

The terminal device 100 is used by a user who uses the content monitoring service according to the present technology. Examples of the terminal device 100 include a smartphone, a laptop computer, a tablet terminal, a camera, and a wearable device.

In the present technology, in order to use the content monitoring system 10, the user needs to install in advance a dedicated application on the terminal device 100 used by the user.

The terminal device 100 and the server device 1000 can communicate with each other through the Internet. Additionally, the terminal device 100 can communicate with other terminal devices 100 through a blockchain network. Moreover, the terminal device 100 can directly communicate with other terminal devices 100 by a peer-to-peer network.

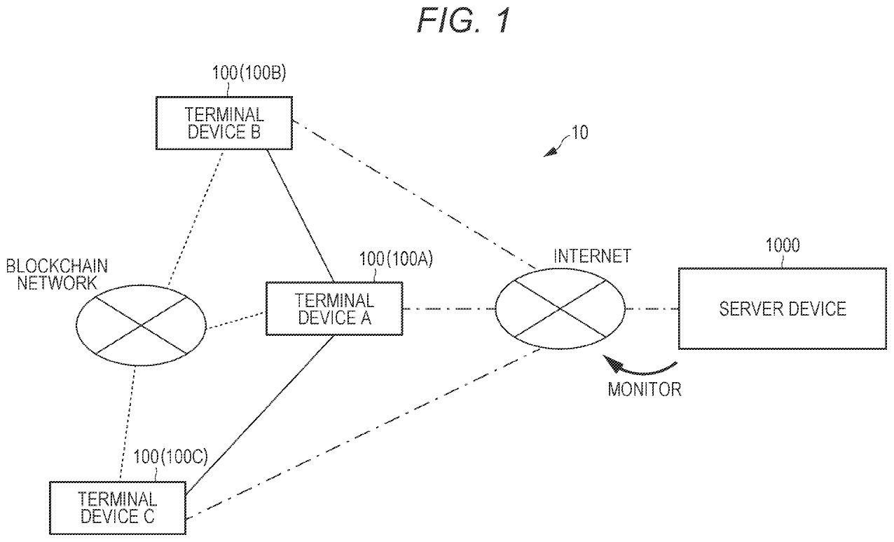

In FIG. 1, the solid line shows the peer-to-peer direct communication between the terminal devices 100 (100A, 100B, 100C). In direct communication between the terminal devices 100, images, approval confirmation, and metadata (details will be described later) are transmitted. Additionally, the broken line shows the blockchain network. The terminal devices 100 are connected through the blockchain network, and the communication history among all the terminal devices 100 is stored as a transaction. Note that images, approval confirmation, and metadata may be exchanged through the blockchain network. Moreover, the alternate long and short dashed lines indicate the connection between the terminal devices 100 and the Internet.

In the present technology, a blockchain network using a peer-to-peer network is used. First, the blockchain system will be described. Note that the peer-to-peer network is sometimes referred to as a peer-to-peer distributed file system.

Blockchain data distributed in the blockchain network is data in which multiple blocks are connected like a chain. In each block, one or more target data is stored as a transaction (transaction record).

Examples of blockchain data according to the present embodiment include blockchain data used for exchanging data of virtual currency such as Bitcoin. The blockchain data used for exchanging data in the blockchain includes, for example, a hash of the immediately preceding block and a special value called a nonce. The hash of the immediately preceding block is used to determine whether or not it is a “correct block” that is correctly connected to the immediately preceding block. Nonce is used to prevent spoofing in hash-based authentication, and tampering is prevented by using nonce. Examples of nonce include a character string, a digit sequence, or data indicating a combination thereof.

Additionally, in blockchain data, the data of each transaction is digitally signed using an encryption key or is encrypted using an encryption key. Additionally, a time stamp indicating the created date and time may be included. Additionally, the data of each transaction is made public and shared throughout the peer-to-peer network. By checking this transaction, it is possible to check the action history of the user who uses the service.

Note that in some blockchain systems, the same record is not necessarily retained throughout the peer-to-peer network. A transaction can be generated by any blockchain network participant. The person who created the transaction does not have to be a person who signed the transaction.

Additionally, in a blockchain system, by using sidechain technology, for example, blockchain data used for exchanging existing virtual currency data such as Bitcoin blockchain data can include other target data different from virtual currency. Here, the other target data different from virtual currency in the present embodiment is image data.

In this way, by using blockchain data for information management, information is retained on the network without being tampered with. Additionally, by using blockchain data, a third party who wants to use information included in a blockchain can access the information included in the blockchain by having predetermined authority.

Additionally, a blockchain is also referred to as a distributed ledger technology, and all data exchanges over the blockchain system are stored as a history. As a result, all users who use the terminal device 100 connected by the blockchain system and the business operator who provides the content monitoring server can check the history of all data exchanges on the blockchain and also can trace the exchanged data. Note that while Bitcoin is a typical example of using blockchain technology, Bitcoin is only a part of use of blockchain technology, and the present technology is not limited to the blockchain technology used in Bitcoin.

In the content monitoring system 10, a user (hereinafter referred to as output user) who intends to output an image to the outside of his/her own terminal device 100 transmits an approval confirmation as to whether or not to approve of the external output to a user (hereinafter referred to as related user) related to the image, and performs various processing according to the response to the approval confirmation made by the related user.

Examples of a related user include a user who appears as a subject in the image, and a user whose predetermined information such as personal information appears in the image. In this description, it is assumed that the terminal device 100A is the terminal device 100 of the output user (user A), and the terminal device 100B and the terminal device 100C are the terminal devices 100 of the related users (user B and user C).

Transmission of approval confirmation from the output user to the related user and the response to the approval confirmation from the related user to the output user are performed by direct peer-to-peer exchange between the terminal devices 100. Additionally, images and metadata transmitted together with the approval confirmation from the output user to the related user are also directly exchanged peer-to-peer between the terminal devices 100. Although It is not necessary to exchange approval confirmation, images, and metadata between the terminal devices 100 through the Internet, exchange through the Internet is not excluded.

Examples of external output of an image include all modes of outputting an image to the outside of the user's own terminal device 100 through a network, such as posting to an image sharing site or a social networking site on the Internet, transmitting the image by attaching it to message functions such as e-mail, storing the image in the cloud or an external server, and other uploading of the image to the Internet.

[1-2. Configuration of Terminal Device 100]

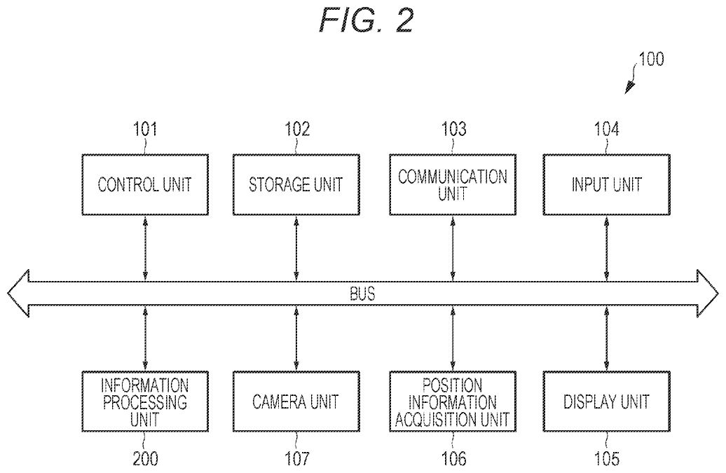

Next, a configuration of the terminal device 100 will be described with reference to FIG. 2. The terminal device 100 includes a control unit 101, a storage unit 102, a communication unit 103, an input unit 104, a display unit 105, a position information acquisition unit 106, a camera unit 107, and an information processing unit 200.

The control unit 101 includes a central processing unit (CPU), a random access memory (RAM), a read only memory (ROM), and other parts. The ROM stores a program and the like to be read and operated by the CPU. The RAM is used as a work memory of the CPU. The CPU controls the entire terminal device 100 by executing various processing and issuing commands according to the program stored in the ROM.

The storage unit 102 is a storage medium including, for example, a hard disc drive (HDD), a semiconductor memory, a solid state drive (SSD), or the like, and stores image data captured by the camera unit 107, image data acquired through another device or the Internet, content data, in addition to applications and the like.

The communication unit 103 is a module that communicates with another terminal device 100 using a blockchain network or a peer-to-peer network according to a predetermined communication standard, and further, communicates with an external device, the server device 1000, or the like through the Internet. Communication methods include wireless local area network (LAN) such as wireless fidelity (Wi-Fi), fourth generation mobile communication system (4G), broadband, Bluetooth (registered trademark), and the like.

The input unit 104 is various input devices for the user to input an instruction to the terminal device 100. Examples of the input unit 104 include a button and a touch screen integrated with the display unit 105. When an input is made to the input unit 104, a control signal corresponding to the input is generated and output to the control unit 101. Then, the control unit 101 performs arithmetic processing and control corresponding to the control signal.

The display unit 105 is a display device or the like for displaying content data such as images and videos, a user interface of the terminal device 100, and an interface for the user to use the service of the content monitoring system 10, for example. Examples of a display device include a liquid crystal display (LCD), a plasma display panel (PDP), and an organic electro luminescence (EL) panel. Note that in addition to the display unit 105, the terminal device 100 may include a speaker that outputs audio as an output device.

The position information acquisition unit 106 includes global positioning system (GPS) and simultaneous localization and mapping (SLAM) functions, and acquires the position of the terminal device 100 as coordinate information, for example, to supply it to the information processing unit 200.

The camera unit 107 includes an image sensor, an image processing LSI, and the like, and has a camera function capable of capturing still images and videos. Note that the camera unit 107 is not an essential component of the terminal device 100.

The information processing unit 200 is a processing unit configured by the terminal device 100 executing a dedicated application (program). The dedicated application may be installed in the terminal device 100, or may be distributed by download, storage medium, or the like so that the user can install it by himself/herself. Note that the information processing unit 200 may be implemented not only by a program but also by combining a dedicated device, a circuit, or the like which is hardware having the same function. The information processing unit 200 corresponds to an information processing device in the claims.

[1-1. Configuration of Information Processing Unit 200]

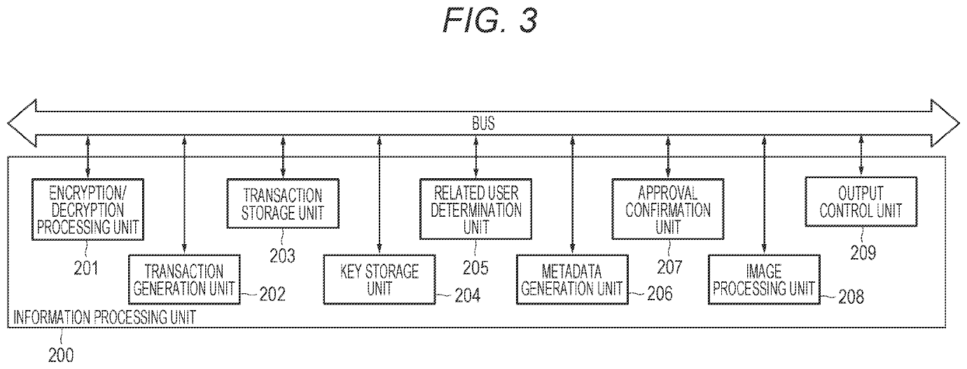

Next, a configuration of the information processing unit 200 will be described with reference to FIG. 3. The information processing unit 200 includes an encryption/decryption processing unit 201, a transaction generation unit 202, a transaction storage unit 203, a key storage unit 204, a related user determination unit 205, a metadata generation unit 206, an approval confirmation unit 207, an image processing unit 208, and an output control unit 209.

The encryption/decryption processing unit 201 performs predetermined encryption processing on an image that the output user intends to output externally. The encryption method may be any method as long as it can protect the personal information in the image. Additionally, in a case where the terminal device 100 receives an encrypted image from another terminal device 100, the encryption/decryption processing unit 201 decrypts the image so that the user can see it.

The transaction generation unit 202 is a processing unit that generates a transaction that is transaction data in the blockchain system described above in the description of the blockchain.

The transaction storage unit 203 stores the transaction generated by the transaction generation unit 202 and the transaction generated by the transaction generation unit 202 of another terminal device 100 and acquired through the blockchain network.

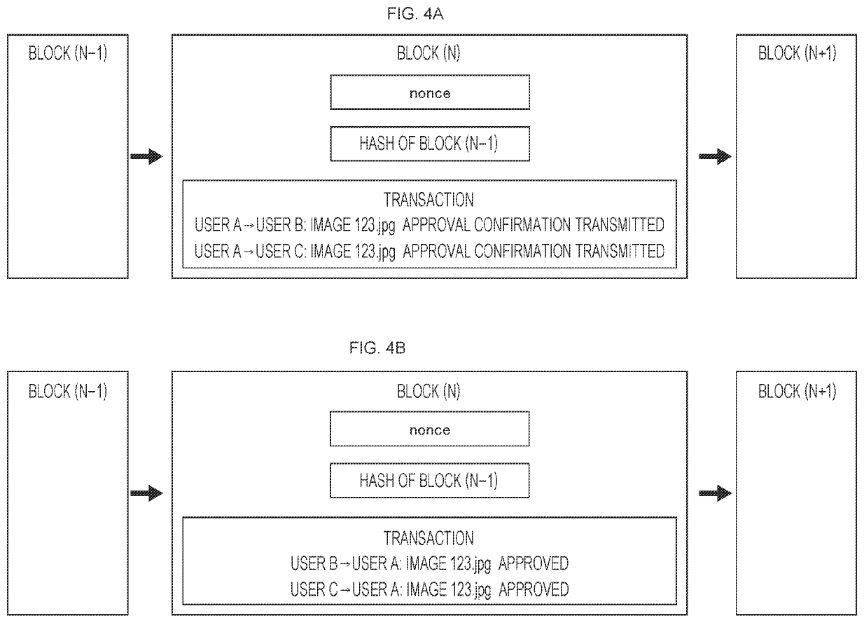

The transaction will be described with reference to FIG. 4. FIG. 4 is a schematic diagram showing a unit referred to as a “block” that stores a record of transactions that occur in a blockchain network. In addition to the transaction record, each block stores information called a hash value that indicates the contents of the previous block. Hence, as shown in FIG. 4, the hash value of block (N−1), which is the previous block, is stored in block (N). Also, in addition to transaction data and the hash value, a nonce is stored in each block of the blockchain.

In the example of FIG. 4A, the block stores the file name of the image for which to confirm approval and a transaction indicating that an approval confirmation has been transmitted from user A who is the output user to users B and C who are related users. In the example of FIG. 4B, the block stores the file name of the image for which to confirm approval and a transaction indicating that an approving response has been made by users B and C who are related users for the approval confirmation from user A who is the output user. Thus, in the present technology, the entire history of the exchange (transaction) between the output user and the related user is recorded in the blockchain.

The key storage unit 204 stores a public key and a private key in the blockchain system.

The related user determination unit 205 determines a related user who is the transmission target of an approval confirmation on the basis of position information obtained by the position information acquisition unit 106, network information obtained from the communication unit 103, information obtained from the Internet, and the like. A related user can be determined by various methods. For example, the owner of the terminal device 100 using the same network (physically the same line) as the network used by the output user is determined as a related user. Additionally, the owner of the terminal device 100 within a predetermined range including the position of the terminal device 100 of the output user is determined as a related user by position information obtained by the GPS as the position information acquisition unit 106. Additionally, by linking with social networking services on the Internet such as Facebook, it is possible to regard only the user who is registered as a friend (may also be referred to as follower depending on service) of the output user in the social networking service as a related user, among users using the same network mentioned above and users within the neighborhood range. Moreover, the related users detected by the above method may be displayed as candidates on the display unit 105 of the terminal device 100, and the output user may be prompted to select the user to transmit the approval confirmation.

The metadata generation unit 206 generates metadata to be transmitted to the related user's terminal device 100 together with an image from the output user's terminal device 100. Metadata includes information indicating the related user to which the approval confirmation is transmitted from the output user, the number of divisions in an image in a case where the image is divided and partially deleted by the image processing unit 208 in each terminal device 100 of multiple related users, and identification information for identifying an image, for example. The metadata generation unit 206 can determine the number of divisions on the basis of the number of related users determined by the related user determination unit 205 and include it in the metadata. Additionally, the deletion portion of an image may be determined on the basis of a predetermined algorithm, multiple division methods may be presented to the output user and the user may select a method, or the output user may determine the dividing portion.

The approval confirmation unit 207 generates an approval confirmation message for confirming approval of external output of an image with the terminal device 100 of the related user, and performs transmission processing through the communication unit 103. Moreover, upon receipt of responses to the approval confirmation from related users, the approval confirmation unit 207 performs processing of checking whether or not approval has been confirmed for all related users, which related user disapproves, and which related user has not responded.

The image processing unit 208 performs processing on the terminal device 100 of the related user to divide the received image into the number of divisions indicated by the metadata, and further, to delete the portion indicated by the metadata. Moreover, if necessary, the image processing unit 208 performs processing on the terminal of the related user to decrypt the divided and partially deleted image.

In the present technology, an image transmitted to the terminal device 100 of the related user is divided and partially deleted by the image processing unit 208 after being viewed by the related user a predetermined number of times (e.g., once). As a result, it becomes impossible for the related user to see the full image. This method is adopted because an image for which the output user confirms approval of external output may contain personal information of each related user or the like, and if it continues to exist in the terminal device 100 of each related user in a full form, there is a possibility that the image may leak to the outside. By partially deleting the image, even if the image leaks to the outside from the terminal device 100 of the related user, the image is not in a full form, so that damage caused by the image leak can be minimized. Note that although the opportunity for the related user to view the image is limited, it is considered sufficient at least to be able to check what the image is like when responding to the approval confirmation.

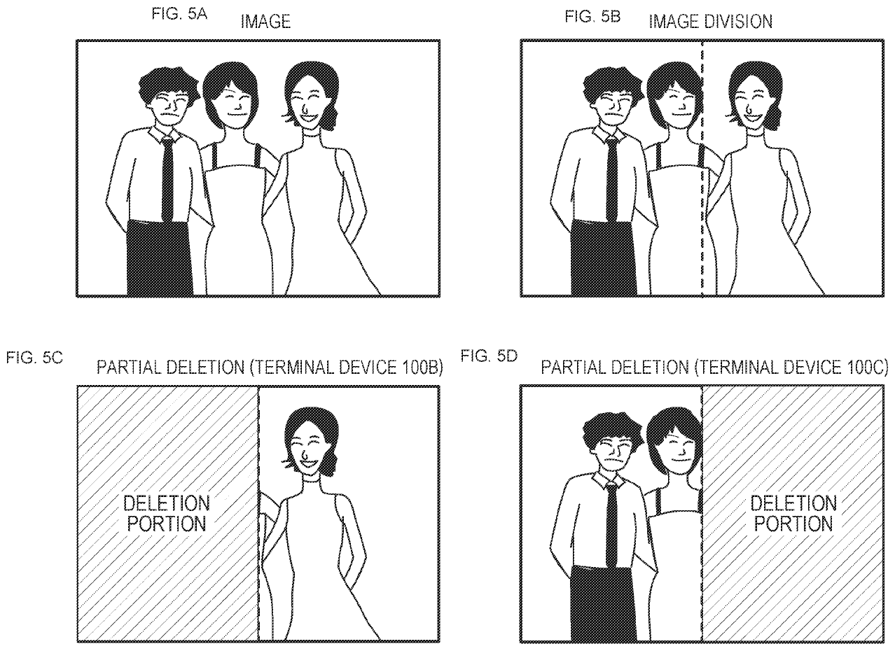

Deletion of a predetermined portion (deletion portion) in an image will be described using a specific example. First, assume that the terminal device 100A (user A) transmits an approval confirmation for the image shown in FIG. 5A to the terminal device 100B (user B) and the terminal device 100C (user C), and this image is the target of division and deletion.

The image processing unit 208 of the terminal device 100B and the image processing unit 208 of the terminal device 100C each divide the image into equal parts by the number of related users (user B and user C, total of two in FIG. 5) on the basis of metadata as shown in FIG. 5B. Then, since the metadata also includes information on which part of the divided image is to be deleted, the image is partially deleted by referring to the information.

For example, FIG. 5C shows the deletion portion in the terminal device 100B, and FIG. 5D shows the deletion portion in the terminal device 100C. In this way, the terminal devices 100 of the multiple related users delete different parts. This means that the images are deleted such that the original image is reproduced if undeleted portions of the images are collected. For example, in a case where the number of related users is three, the image is divided into three and undergoes deletion processing.

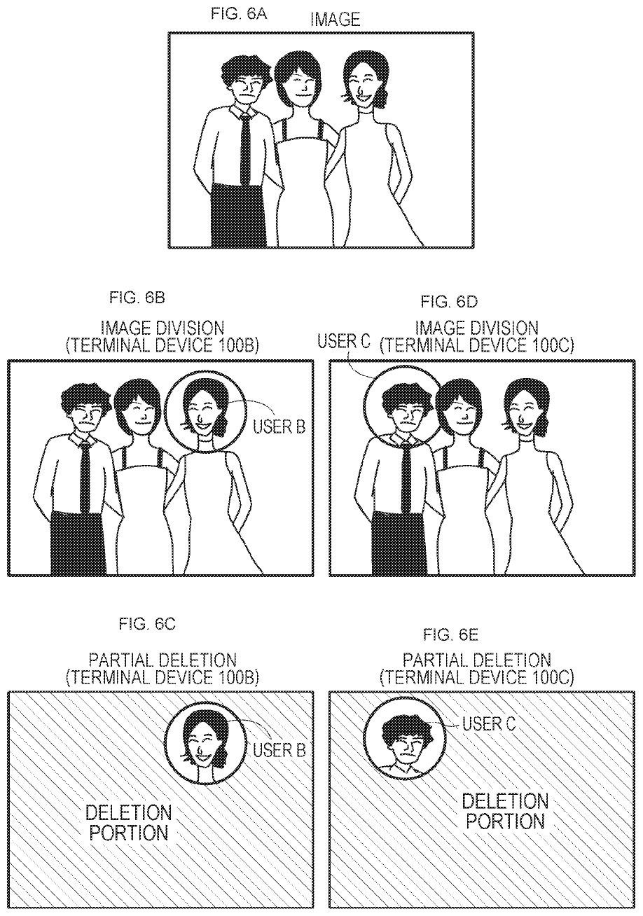

Further, as shown in FIG. 6, a known face recognition technology may be used for the deletion portion. Assume that the terminal device 100A (user A) transmits an approval confirmation for the image shown in FIG. 6A to the terminal device 100B (user B) and the terminal device 100C (user C), and this image is the target of division and deletion.

As shown in FIG. 6B, the terminal device 100B recognizes the face of user B who is the owner of the terminal device 100B from the image. Then, as shown in FIG. 6C, a portion other than a predetermined area including the face of user B is deleted. Meanwhile, as shown in FIG. 6D, the terminal device 100C recognizes the face of user C who is the owner of the terminal device 100C from the image. Then, as shown in FIG. 6E, a portion other than a predetermined area including the face of user C is deleted. In this way, the terminal devices 100 of the multiple related users delete different parts. This means that the images are deleted such that the original image is reproduced if undeleted portions of the images are collected.

The face to be recognized in this case is based on face information of the related user stored in advance in the terminal device 100. For example, in a case where the terminal device 100 uses a face recognition system to release an operation lock, face information registered for the face recognition system may be used to determine the division/deletion portion.

Note that although the image is partially deleted by the image processing unit 208, the metadata may be stored in the terminal device 100 in the received state without being deleted, or may be deleted.

The output control unit 209 controls the external output of an image on the basis of the response to the approval confirmation from the related user.

The terminal device 100 and the information processing unit 200 are configured as described above. Note that the terminal device 100 and the information processing unit 200 can be used as a terminal device of an output user or a terminal device of a related user.

[1-4. Use of Content Monitoring System 10]

[1-4-1. User Registration Processing]

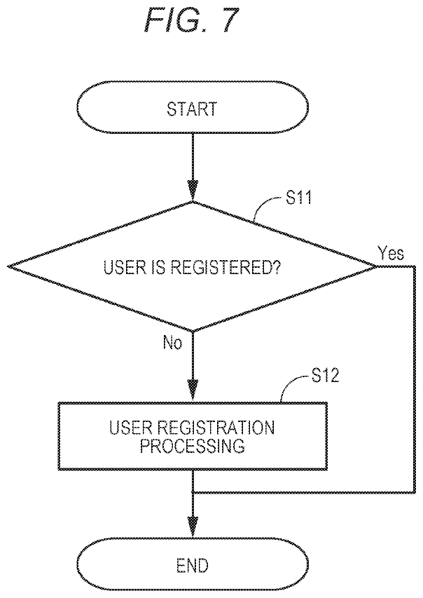

Next, use of the content monitoring system 10 will be described. First, user registration processing for the content monitoring system 10 will be described with reference to the flowchart of FIG. 7. In order to use the content monitoring system 10, both the output user and the related user need to be registered as a user of the server device 1000 of the content monitoring system 10.

First, in step S11, it is confirmed whether the user is registered. Whether the user is registered can be confirmed by checking a user name, device ID information of the user's terminal device 100, and the like against a database having registered user information stored in the server device 1000. Additionally, the display unit 105 of the terminal device 100 may output a message to confirm whether the user is registered to prompt the user for confirmation and input.

If the user is registered, the processing ends (Yes in step S11). On the other hand, if the user is not registered, the processing proceeds to step S12 (No in step S11).

Then, in step S12, processing is performed to register the user who is the owner of the terminal device 100 as a new user in the database of the server device 1000. This registration processing is performed by displaying a user interface that enables input of registration contents on the display unit 105 of the terminal device 100 to prompt the user to input the contents, and transmitting the contents input by the user to the server by communication by the communication unit 103. Alternatively, the registration processing may be performed by transmitting identification information such as a device ID of the terminal device 100 to the server.

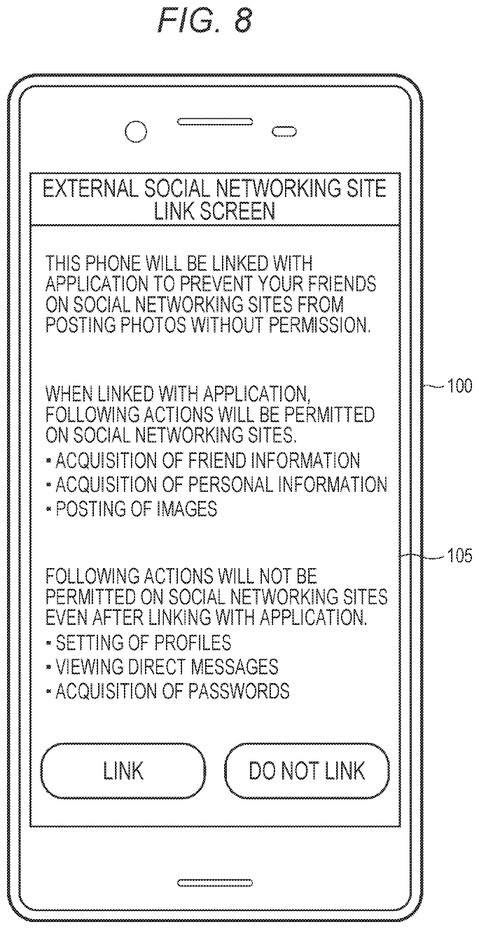

Note that instead of user registration, user information already registered in an existing service on the Internet such as an external social networking site may be used. In that case, the content monitoring system 10 may be implemented on the service on the Internet, approval of use of the service by the content monitoring system 10 may be requested as shown in FIG. 8, and information of the approving user may be acquired from a server of the service on the Internet. Moreover, the content monitoring system 10 may be linked as a service independent from existing services on the Internet to share user information.

[1-4-2. Approval Confirmation Transmission Processing]

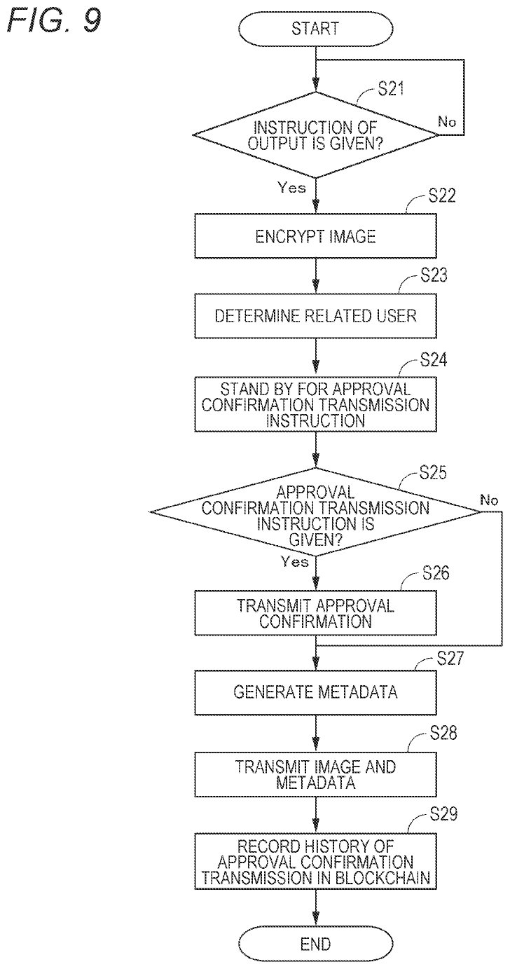

Next, approval confirmation transmission processing to the terminal device 100 of the related user by the terminal device 100 of the output user will be described with reference to FIG. 9.

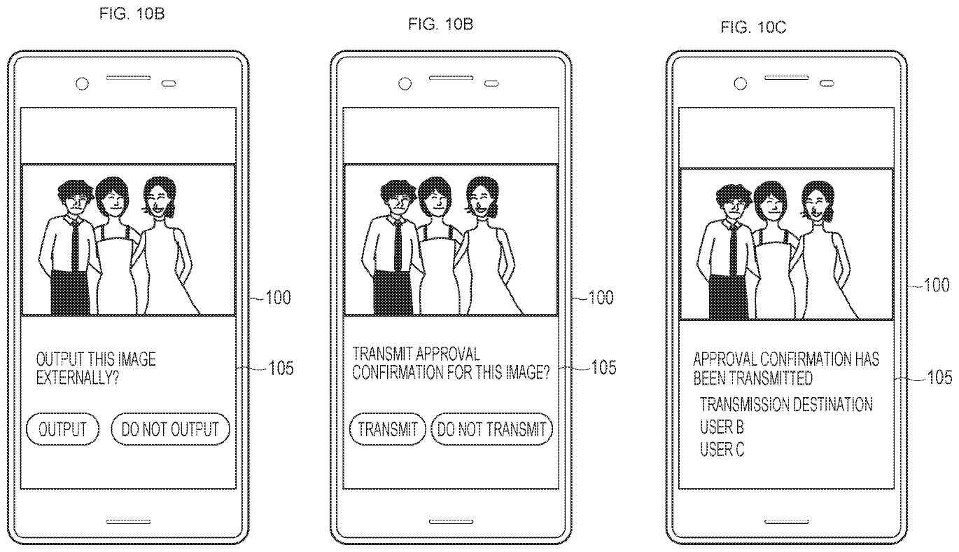

First, in step S21, it is determined whether or not the output user makes an input giving an instruction for external output of an image. This determination can be made by acquiring contents input to the input unit 104 of the terminal device 100 by the user. For example, a user interface as shown in FIG. 10A is displayed on the display unit 105 of the terminal device 100 to prompt the output user to input whether or not to perform external output. Note that the image may be an image captured by the camera unit 107 of the terminal device 100, an image captured by another imaging device and stored in the terminal device 100, an image acquired on the Internet, or the like. If the user makes an input giving the instruction for external output of the image, the processing proceeds to step S22 (Yes in step S21).

Next, the encryption/decryption processing unit 201 encrypts the image for which the user gave the instruction for external output in step S22.

Next, in step S23, the related user determination unit 205 determines the related user. As described above, a related user can be determined by various methods such as regarding the owner of the terminal device 100 using the same wireless network as a related user, and regarding the owner of the terminal device 100 within a predetermined range in the position information obtained by GPS as a related user.

Next, in step S24, the information processing unit 200 enters a stand-by state for an approval confirmation transmission instruction from the output user. In the approval confirmation transmission instruction stand-by state, a user interface as shown in FIG. 10B is displayed on the display unit 105 of the terminal device 100. Then, if the output user gives an approval confirmation transmission instruction, the processing proceeds from step S25 to step S26 (Yes in step S25).

Then, in step S26, an approval confirmation is transmitted to the terminal devices 100 of all related users from the terminal device 100 of the output user by processing of the approval confirmation unit 207. When the approval confirmation is transmitted, it is preferable to display the fact that the approval confirmation has been transmitted as shown in FIG. 10C on the display unit 105 of the terminal device 100 of the output user. Then, the processing proceeds to step S27.

On the other hand, if the output user does not give any approval confirmation transmission instruction, that is, if the output user does not confirm approval, the processing proceeds from step S25 to step S27 (No in step S25).

Next, in step S27, the metadata generation unit 206 generates metadata. Then, in step S28, the image and metadata which are the target of approval confirmation are transmitted to the terminal device 100 of the related user.

Next, in step S29, the history of transmitting the approval confirmation to the terminal device 100 of the related user from the terminal device 100 of the output user is recorded as a transaction in the blockchain. The recording in the blockchain is performed by generating a transaction including the contents to be recorded by the transaction generation unit 202 and transmitting the transaction to the blockchain network by the communication unit 103.

Thus, the terminal device 100 of the output user transmits the approval confirmation to the terminal device 100 of the related user. In a case where the output user confirms approval, an approval confirmation, an image, and metadata are transmitted to the related user. Note that while the image and the metadata are transmitted after transmission of the approval confirmation in the flowchart of FIG. 9, they may be transmitted at the same time. On the other hand, in a case where the output user does not confirm approval, an image and metadata are transmitted to the related user. In this case, the approval confirmation may be transmitted at any timing after the transmission of the image and the metadata.

[1-4-3. Response Processing]

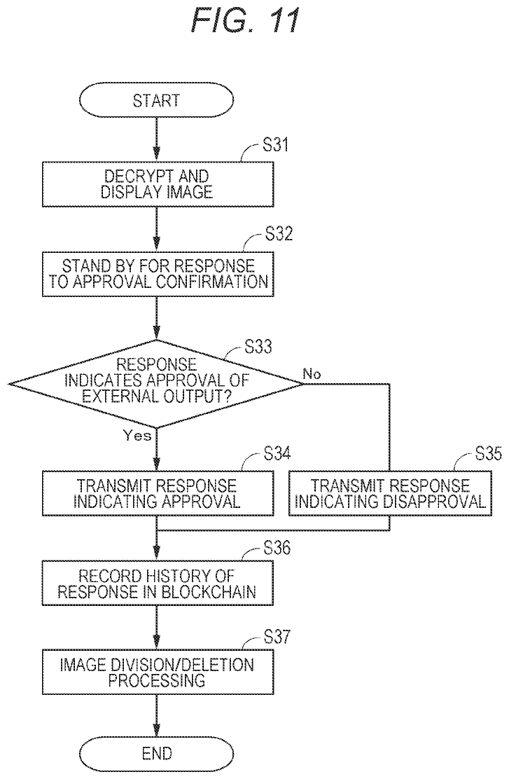

Next, response processing in the terminal device 100 of the related user who has received the approval confirmation from the output user will be described with reference to FIG. 11.

First, in step S31, an image is decrypted by the encryption/decryption processing unit 201, and the image is displayed on the display unit 105. As a result, the related user can check what kind of image the output user is requesting approval confirmation of external output.

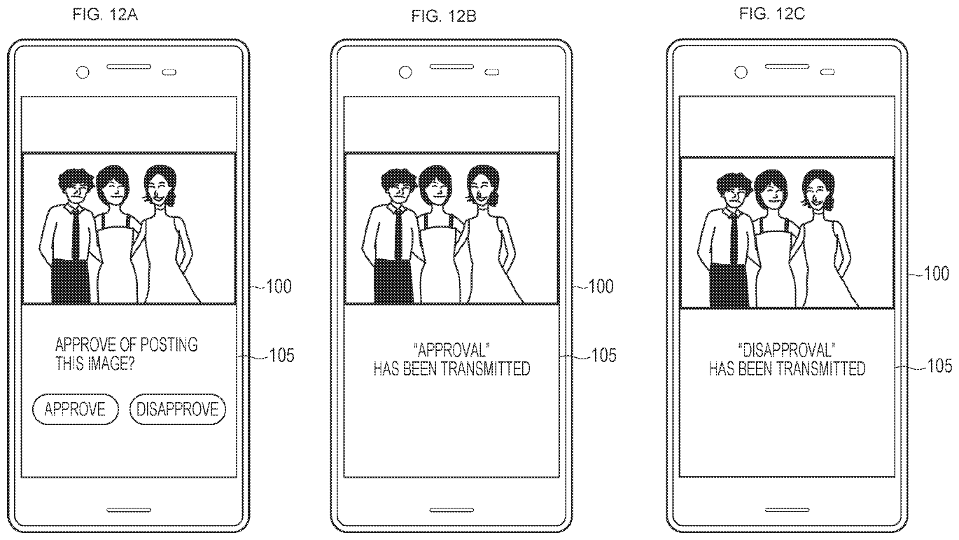

Next, in step S32, a message indicating approval confirmation from the output user as shown in FIG. 12A is displayed on the display unit 105, and the output user enters a stand-by state of a response input to the approval confirmation. In this state, the related user can input an approving or disapproving response to the approval confirmation.

If the related user approves of external output of the image by the output user, the processing proceeds from step S33 to step S34 (Yes in step S33). Then, in step S34, a response indicating approval of external output of the image is transmitted to the terminal device 100 of the output user from the terminal device 100 of the related user using the blockchain. At that time, as shown in FIG. 12B, it is preferable to display, on the display unit 105, the fact that an approving response has been transmitted.

On the other hand, if the related user does not approve of external output by the output user, the processing proceeds from step S33 to step S35 (No in step S33). Then, in step S35, a response indicating disapproval of external output of the image is transmitted to the terminal device 100 of the output user from the terminal device 100 of the related user using the blockchain. At that time, as shown in FIG. 12C, it is preferable to display, on the display unit 105, the fact that a disapproving (not approve) response has been transmitted.

When a related user receives an approval confirmation, he/she should determine the response to the approval confirmation by determining whether he/she is in the image and whether to allow the image of himself/herself to be output externally. Additionally, other than the image of himself/herself, the user should also check whether or not the image contains any private subject such as a document containing personal information regarding himself/herself or people related to him/her (family members and the like). If it is determined that a subject that should not be output externally exists in the image, the related user should give a disapproving response to the approval confirmation.

Next, in step S36, the history of transmitting a response to the approval confirmation is recorded as a transaction in the blockchain. Note that if the related user does not input a response within a predetermined period from the time of receiving the approval confirmation, a history indicating disapproval or no response should be recorded in the blockchain.

Next, in step S37, the image processing unit 208 performs image division/deletion processing. As a result, the related user cannot view the image in a full form unless the image is decrypted.

Note that a response to the output user from one related user is also transmitted to all other related users.

Additionally, on the terminal device 100 of the related user, the related user may be notified by a push notification when an approval confirmation is received from the output user.

[1-4-4. External Output Processing]

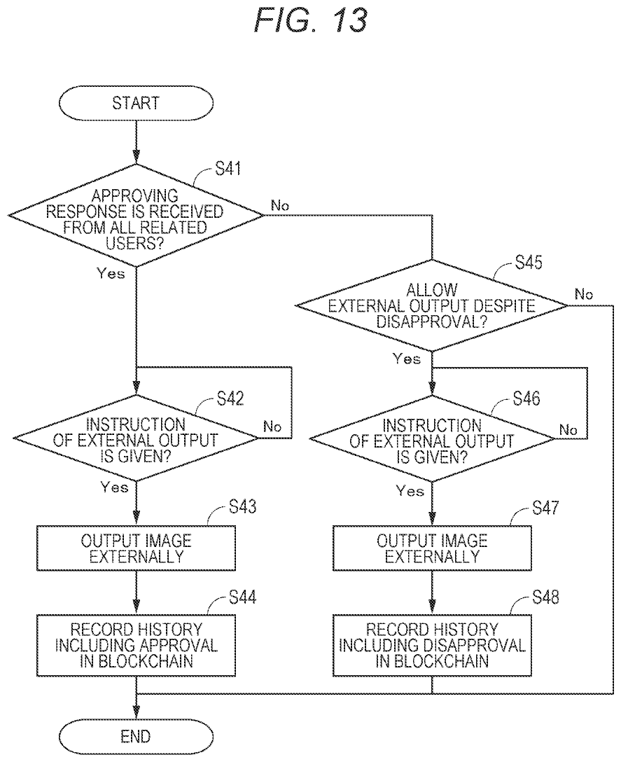

Next, with reference to FIG. 13, external output of an image by the terminal device 100 of the output user who has received a response to the approval confirmation from the related user will be described.

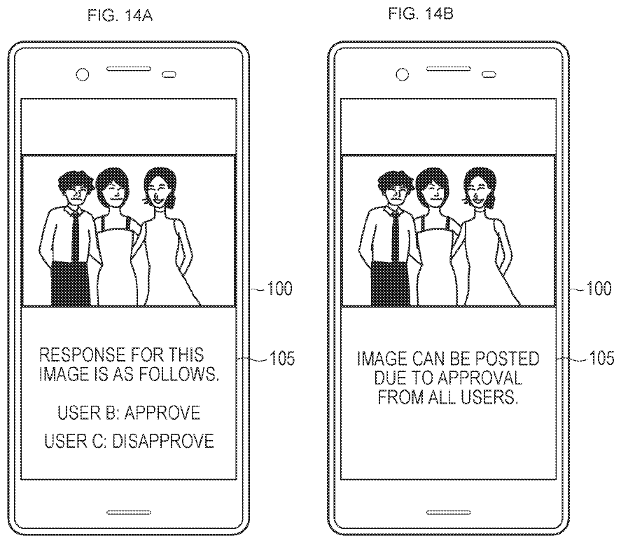

In step S41, the approval confirmation unit 207 checks the response received from the related user. When a response is received from a related user, it is preferable to display the response content as shown in FIG. 14A on the display unit 105 of the terminal device 100 of the output user.

If a response approving of the external output has been received from all the related users, the processing proceeds to step S42 (Yes in step S41). At this time, as shown in FIG. 14B, it is preferable to display, on the display unit 105, the fact that external output of the image has been enabled because approving responses have been received from all the related users.

Then, if the output user inputs an instruction for external output to the terminal device 100, the processing proceeds from step S42 to step S43 (Yes in step S42). Then, in step S43, the output control unit 209 outputs the image externally from the terminal device 100 of the output user.

Moreover, in step S44, the history of the external output with an approving response is recorded as a transaction in the blockchain. Note that regarding steps S43 and S44, the external output of the image in step S43 does not necessarily have to be performed first, and the steps may be performed at the same time, or the recording to the blockchain in step S44 may be performed first.

On the other hand, if an approving response has not been received from all the related users in step S41, that is, if there is a disapproving response or there is no response, the processing proceeds from step S41 to step S45 (No in step S41).

Next, in step S45, it is determined whether or not the output user can output the image externally even if there is disapproval or there is no response. If there is a disapproving response or there is no response from a related user, it is desirable to disable external output of the image in normal operation because not all the related users have approved of external output of the image. Note, however, that external output of an image may enabled even if there is a disapproving response or no response. This is determined by the setting of a management company that operates the content monitoring system 10 or prior agreement between the output user and the related user, for example, and set in the information processing unit 200. Hence, this determination can be made by checking the settings in the information processing unit 200.

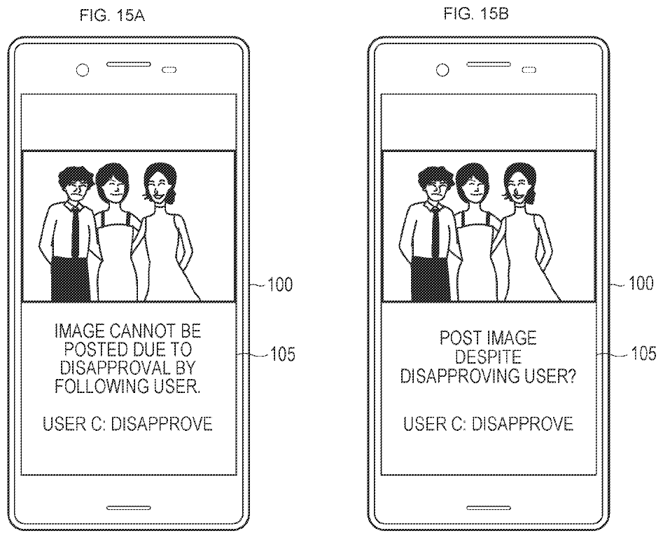

Note that at this time, as shown in FIG. 15A, it is preferable to display, on the display unit 105, the fact that external output has been disabled due to a disapproving response or no response. Additionally, in a case where the image can be externally output (uploaded) even if there is disapproval, as shown in FIG. 15B, a display may be shown to confirm whether or not to externally output (upload) even if there is disapproval.

Then, when the output user inputs an instruction for external output to the terminal device 100, the processing proceeds from step S46 to step S47 (Yes in step S46). Then, in step S47, the output control unit 209 outputs the image externally from the terminal device 100 of the output user.

Moreover, in step S48, the history of the external output with disapproval (or no approval) is recorded as a transaction in the blockchain. Note that regarding steps S47 and S48, the external output of the image in step S47 does not necessarily have to be performed first, and the steps may be performed at the same time, or the recording to the blockchain in step S48 may be performed first.

If in step S45 the image cannot be output externally in a case where there is disapproval or there is no response, the processing ends without external output of the image (No in step S45).

Note that if there is no response to the approval confirmation from the related user, external output of the image may be enabled by considering the situation as approval after passage of a predetermined period of time from transmission of the approval confirmation, external output of the image may be disabled by considering the situation as disapproval, or external output of the image may be enabled despite the disapproval. What processing to perform in a case where there is no response within a predetermined period is determined by the setting of a management company that operates the content monitoring system 10 or prior agreement between the output user and the related user, for example.

Note that in a case where the image is output externally when there has been a disapproving response to the approval confirmation, it is preferable to record the disapproval response as well as a transaction in the blockchain. Similarly, in the case where the image is output externally when there has not been a response to the approval confirmation for a predetermined period, too, it is preferable to record the fact that the image has been output externally with no response as a transaction in the blockchain.

Note that when the output user is allowed to output an image externally by obtaining approving responses from all related users, the related users may also be allowed to output the image externally. Note, however, that since the image is partially deleted in the terminal device 100 of the related user, in order to output the image externally, the related user needs to request transmission of the image to the output user, or request transmission of partial images to other related users on the basis of metadata and decrypt the image from multiple partial images.

[1-4-5. Image Decryption Processing]

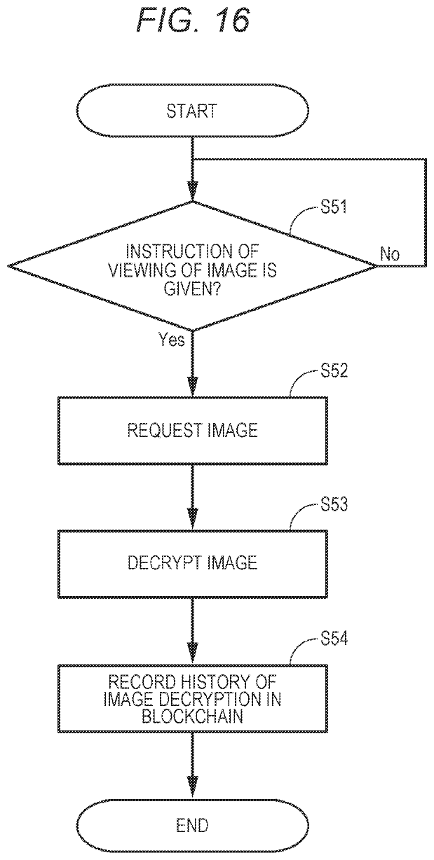

Next, with reference to FIG. 16, image decryption processing for a related user to view an image after the image has undergone division and deletion will be described. As described above, an image transmitted to the terminal device 100 of a related user is divided and partially deleted after being viewed by the related user a predetermined number of times (e.g., once). As a result, it becomes impossible for the related user to view the full image thereafter.

However, there may be cases where the related user later wants to check what the image is like again. In such a case, the related user causes the information processing unit 200 to execute this image decryption processing.

First, in step S51, it is determined whether or not a related user inputs an instruction for viewing an image to the terminal device 100, and if an instruction for viewing an image is input, the processing proceeds to step S52 (Yes in step S51).

Next, in step S52, an image transmission request is transmitted to the terminal device 100 of the output user. This partial image is a portion of the image that has not been deleted in the terminal device 100 of each related user. Hence, collecting all partial images is collecting each part included in the image.

Then, in step S53, the image processing unit 208 decrypts the divided and partially deleted image by using the partial images transmitted from other related users, to create a full image.

This image decryption will be described. Metadata includes information on the related user to whom the output user has transmitted an approval confirmation, and information indicating which part of the image is deleted and which part remains in the terminal device 100 of each related user. Hence, by referring to the metadata, it is possible to grasp who the related users are and which related user retains which part of the image.

Accordingly, the related user who wants to view the full image refers to metadata, requests each of the other related users for the part of the image retained by the related user, and acquires a partial image. Then, the image processing unit 208 decrypts the full image from the collected partial images. As a result, the related user can view the image in its full form again. Note that it is preferable to divide and partially delete the image again after reviewing.

Next, in step S54, the fact that the related user has decrypted the image is recorded as a transaction in the blockchain.

The processing of the present technology is performed as described above. With the content monitoring system 10 according to the present technology, it is possible to know beforehand when a photograph of oneself is to be externally output without permission. Additionally, it is possible to prevent a photograph of oneself from being output externally without permission.

Moreover, by leaving a record of interactions related to images in the blockchain, it is possible to identify the user who externally outputs an image in a case where some problem occurs regarding external output of the image. Additionally, since the interaction between the output user and the related user in the process of externally outputting the image is recorded in all the blockchains, it is possible to confirm who made what decision later.

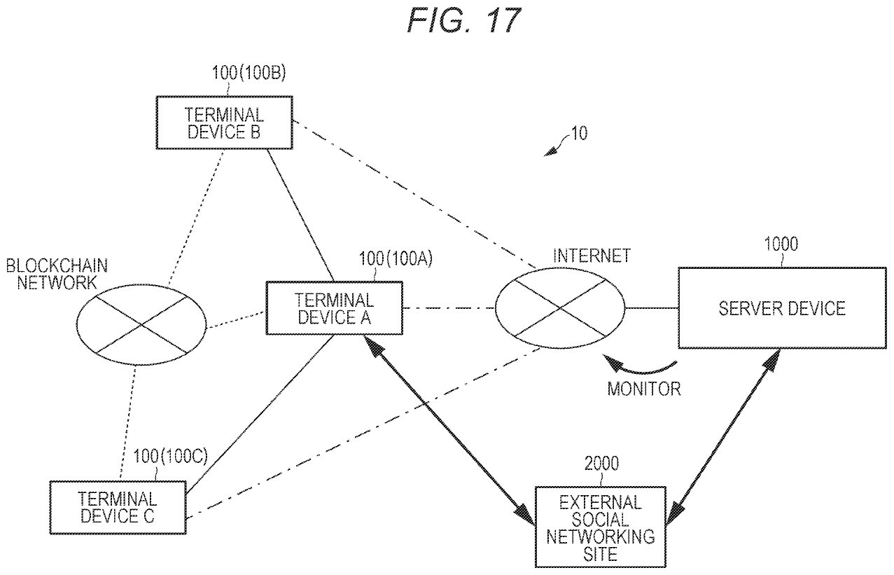

Additionally, as shown in FIG. 17, in a case where the user links the content monitoring system 10 and an external social networking site 2000, when there is a related user of an image that is a target of approval confirmation who is not a user of the content monitoring system 10 but belongs to the external social networking site, it is possible to use personal information existing in the external social networking site 2000 to transmit an approval confirmation to this related user through the external social networking site 2000. Additionally, at that time, it is also possible to propose installation of a dedicated application provided by the content monitoring system 10.

Additionally, by embedding information that can be uniquely identified excluding personal information, such as image hash values, in the blockchain network between users, the content monitoring system 10 can check the information against data made public on the Internet to notify the user of photographs available on the Internet. Additionally, the content monitoring system 10 can accept deletion of data on the Internet from the notified user, and request a service on the Internet to delete the data.

### 2. Modification

While the embodiment of the present technology has been specifically described above, the present technology is not limited to the above-described embodiment, and various modifications based on the technical idea of the present technology are possible.

In the present technology, the target of approval confirmation is not limited to images, but any content such as video data, audio data, and document data may be used. Moreover, in addition to contents, any data such as a program and software that can be exchanged through a network may be used.

The present technology can also be configured to simply record in the blockchain the fact that any user has output an image externally, instead of transmitting an approval confirmation for external output of the image.

While it has been explained that an image received by the terminal device 100 of a related user is divided and partially deleted by the image processing unit 208 in the embodiment, in the terminal device 100 of the related user, the image may be left in full form without undergoing division and deletion.

A known subject recognition technology may be used to detect whether or not there is a subject including personal information in an image and prompt the output user to transmit an approval confirmation. Additionally, when a related user receives an image from the output user, a known subject recognition technology may be used to detect whether or not there is a subject related to privacy in the image, and present information for deciding the response to an approval confirmation.

A program according to the present technology may be linked with a service on the Internet such as a social networking site, and a message prompting the user to install the program may be transmitted on the social networking site, for example.

The present technology can also be configured in the following manner.

(1)

An information processing program including:

operating on one terminal device;

transmitting an approval confirmation requesting approval of external output of an image to one or multiple other terminal devices other than the one terminal device; and

outputting the image externally on the basis of a response to the approval confirmation from the other terminal device.

(2)

The information processing program according to (1), in which

in a case where the response approves of external output of the image, external output of the image is enabled.

(3)

The information processing program according to (1) or (2), in which

in a case where the response disapproves of external output of the image, external output of the image is disabled.

(4)

The information processing program according to any one of (1) to (3), in which

the image is transmitted together with the approval confirmation from the one terminal device to the other terminal device.

(5)

The information processing program according to (4), in which

metadata is transmitted together with the approval confirmation and the image from the one terminal device to the other terminal device.

(6)

The information processing program according to (5), in which

the metadata includes data indicating the other terminal device to transmit the approval confirmation.

(7)

The information processing program according to any one of (1) to (6), in which

a predetermined portion of the image is deleted.

(8)

The information processing program according to (7), in which

the predetermined portion includes a divided portion other than any one of multiple divided portions formed by dividing the image into multiple portions.

(9)

The information processing program according to (8), in which

the number of divisions of the image is the number of the other terminal devices to which the approval confirmation is transmitted.

(10)

The information processing program according to any one of (7) to (9), in which

the image is reproduced a predetermined number of times and then the predetermined portion is deleted.

(11)

The information processing program according to any one of (1) to (10), in which

the other terminal device includes a terminal device connected to the same network as the one terminal device.

(12)

The information processing program according to any one of (1) to (11), in which

the other terminal device includes a terminal device existing within a predetermined range including a position of the one terminal device.

(13)

The information processing program according to any one of (1) to (12), in which

the one terminal device and the other terminal device are connected by a blockchain network.

(14)

The information processing program according to (13), further including

outputting and storing information indicating a history of processing executed in the one terminal device and the other terminal device in the blockchain network.

(15)

An information processing device including

an approval confirmation unit that operates on one terminal device, and transmits an approval confirmation requesting approval of external output of an image to one or multiple other terminal devices other than the one terminal device, and

an output control unit that controls external output of the image on the basis of a response to the approval confirmation from the other terminal device.

(16)

An information processing method including

transmitting an approval confirmation requesting approval of external output of an image to one or multiple other terminal devices other than one terminal device, and

outputting the image externally on the basis of a response to the approval confirmation from the other terminal device.

### REFERENCE SIGNS LIST

100 Terminal device
200 Information processing unit
207 Approval confirmation unit
209 Output control unit

1. An information processing program comprising:
operating on one terminal device;
transmitting an approval confirmation requesting approval of external output of an image to one or a plurality of other terminal devices other than the one terminal device; and
outputting the image externally on a basis of a response to the approval confirmation from the other terminal device.

2. The information processing program according to claim 1, wherein
in a case where the response approves of external output of the image, external output of the image is enabled.

3. The information processing program according to claim 1, wherein
in a case where the response disapproves of external output of the image, external output of the image is disabled.

4. The information processing program according to claim 1, wherein
the image is transmitted together with the approval confirmation from the one terminal device to the other terminal device.

5. The information processing program according to claim 4, wherein
metadata is transmitted together with the approval confirmation and the image from the one terminal device to the other terminal device.

6. The information processing program according to claim 5, wherein
the metadata includes data indicating the other terminal device to transmit the approval confirmation.

7. The information processing program according to claim 1, wherein
a predetermined portion of the image is deleted.

8. The information processing program according to claim 7, wherein
the predetermined portion includes a divided portion other than any one of a plurality of divided portions formed by dividing the image into a plurality of portions.

9. The information processing program according to claim 8, wherein
the number of divisions of the image is the number of the other terminal devices to which the approval confirmation is transmitted.

10. The information processing program according to claim 7, wherein
the image is reproduced a predetermined number of times and then the predetermined portion is deleted.

11. The information processing program according to claim 1, wherein
the other terminal device includes a terminal device connected to the same network as the one terminal device.

12. The information processing program according to claim 1, wherein
the other terminal device includes a terminal device existing within a predetermined range including a position of the one terminal device.

13. The information processing program according to claim 1, wherein
the one terminal device and the other terminal device are connected by a blockchain network.

14. The information processing program according to claim 13, further comprising
outputting and storing information indicating a history of processing executed in the one terminal device and the other terminal device in the blockchain network.

15. An information processing device comprising
an approval confirmation unit that operates on one terminal device, and transmits an approval confirmation requesting approval of external output of an image to one or a plurality of other terminal devices other than the one terminal device, and
an output control unit that controls external output of the image on a basis of a response to the approval confirmation from the other terminal device.

16. An information processing method comprising
transmitting an approval confirmation requesting approval of external output of an image to one or a plurality of other terminal devices other than one terminal device, and
outputting the image externally on a basis of a response to the approval confirmation from the other terminal device.
